(19) United States
(12) Patent Application Publication
(10) Pub. No.: US 2010/0020064 A1
(43) Pub. Date: Jan. 28, 2010

(54) ELECTROPHORETIC DISPLAY DEVICES

(75) Inventors: Sander Jurgen Roosendaal, Eindhoven (NL); Martinus Hermanus Wilhelmus Maria Van Delden, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/439,695

(22) PCT Filed: Sep. 5, 2007
(86) PCT No.: PCT/IB07/53570

§ 371 Date: Mar. 3, 2009

(30) Foreign Application Priority Data
Sep. 5, 2006 (EP) 06120120.8

(51) Int. Cl. G06F 3/038

(52) U.S. Cl. 345/214; 345/107

(57) ABSTRACT

An electrophoretic display device is driven by carrying out a first display addressing cycle (FIG. 3A), in which the display is addressed as a first set of row groups (52), the same column data set being applied to each row of the row group simultaneously. The number of row groups (52) is less than the number of rows (50), such that at least one row group comprises a plurality of rows. At least one further display addressing cycle (FIG. 3B) addresses all rows of the display with independent image data. This method addresses groups of rows together using the same column data, and thereby reduces the addressing time. The image is presented after the first addressing cycle as a low resolution image, in particular with low vertical resolution. The subsequent addressing cycles then progressively improve the image quality to the final desired image.

This invention relates to electrophoretic display devices.

Electrophoretic display devices are one example of bistable display technology, which use the movement of charged particles within an electric field to provide a selective light scattering or absorption function.

In one example, white particles are suspended in an absorptive liquid, and the electric field can be used to bring the particles to the surface of the device. In this position, they may perform a light scattering function, so that the display appears white. Movement away from the top surface enables the colour of the liquid to be seen, for example black. In another example, there may be two types of particle, for example black negatively charged particles and white positively charged particles, suspended in a transparent fluid. There are a number of different possible configurations.

It has been recognised that electrophoretic display devices enable low power consumption as a result of their bistability (an image is retained with no voltage applied), and they can enable thin and bright display devices to be formed as there is no need for a backlight or polariser. They may also be made from plastics materials, and there is also the possibility of low cost reel-to-reel processing in the manufacture of such displays.

If costs are to be kept as low as possible, passive addressing schemes are employed. The most simple configuration of display device is a segmented reflective display, and there are a number of applications where this type of display is sufficient. A segmented reflective electrophoretic display has low power consumption, good brightness and is also bistable in operation, and therefore able to display information even when the display is turned off.

However, improved performance and versatility is provided using a matrix addressing scheme. An electrophoretic display using passive matrix addressing typically comprises a lower electrode layer, a display medium layer, and an upper electrode layer. Biasing voltages are applied selectively to electrodes in the upper and/or lower electrode layers to control the state of the portion(s) of the display medium associated with the electrodes being biased.

Another type of electrophoretic display device uses so-called “in plane switching”. This type of device uses movement of the particles selectively laterally in the display material layer. When the particles are moved towards lateral electrodes, an opening appears between the particles, through which an underlying surface can be seen. When the particles are randomly dispersed, they block the passage of light to the underlying surface and the particle colour is seen. The particles may be coloured and the underlying surface black or white, or else the particles can be black or white, and the underlying surface coloured.

An advantage of in-plane switching is that the device can be adapted for transmissive operation, or transflective operation. In particular, the movement of the particles creates a passageway for light, so that both reflective and transmissive operation can be implemented through the material. This enables illumination using a backlight rather than reflective operation. The in-plane electrodes may all be provided on one substrate, or else both substrates may be provided with electrodes.

Active matrix addressing schemes are also used for electrophoretic displays, and these are generally required when a faster image update is desired for bright full colour displays with high resolution greyscale. Such devices are being developed for signage and billboard display applications, and as (pixellated) light sources in electronic window and ambient lighting applications. Colours can be implemented using colour filters or by a subtractive colour principle, and the display pixels then function simply as greyscale devices. The description below refers to greyscales and grey levels, but it will be understood that this does not in any way suggest only monochrome display operation.

The invention applies to passive matrix display technologies.

Electrophoretic displays are typically driven by complex driving signals. For a pixel to be switched from one grey level to another, often it is first switched to white or black as a reset phase and to then to the final grey level. Grey level to grey level transitions and black/white to grey level transitions are slower and more complicated than black to white, white to black, grey to white or grey to black transitions.

Typical driving signals for Electrophoretic displays are complex and can consist of different subsignals, for example “shaking” pulses aimed at speeding up the transition, improving the image quality etc.

Further discussion of known drive schemes can be found in WO 2005/071651 and WO 2004/066253.

One significant problem with electrophoretic displays is the time taken to address the display with an image. This addressing time results from the fact that the pixel output is dependent on the physical position of particles with the pixel cells, and the movement of the particles requires a finite amount of time. The addressing speed can be increased by various measures, for example providing pixel-by-pixel writing of image data which only requires movement of pixels a short distance, followed by a parallel particle spreading stage which spreads the particles across the pixel area.

Even with these measures, the display addressing for a large passive matrix display can take hours rather than minutes. This has limited the use of large electrophoretic displays to displays for static images and which are refreshed only infrequently, for example billboard applications.

There is therefore a need to reduce the addressing time for such passive matrix display devices.

According to the invention, there is provided a method of driving an electrophoretic display device, comprising an array of rows and columns of display pixels, the method comprising:

carrying out a first display addressing cycle, in which the display is addressed as a first set of row groups, the same column data set being applied to each row of the row group simultaneously, wherein the number of row groups is less than the number of rows, such that at least one row group comprises a plurality of rows; and

carrying out at least one further display addressing cycle,

wherein in the final addressing cycle, all rows of the display are addressed with independent image data.

This method addresses groups of rows together using the same column data, and thereby reduces the addressing time. The image is presented after the first addressing cycle as a low resolution image, in particular with low vertical resolution. The subsequent addressing cycles then progressively improve the image quality to the final desired image. Each row group may comprise a plurality of rows, for example the same number of rows. In one preferred example, each row group includes 3 rows.

The first row group can comprise a first plurality of adjacent rows, and each next row group can comprise a next plurality of adjacent rows. This provides a simple sequential addressing method, but may not provide the optimum grouping of rows to give the best quality image after the first addressing cycle.

Thus, the row groups may be interlaced. This interlacing may be uniform or it may be determined which rows to group together based on the image content. This enables the image to be used to determine how best to group the rows and obtain the best quality output image after the first addressing cycle.

If image content is used, the rows may be grouped which have least deviation from each other in terms of the image content at each column position along the row. In other words, groups of rows are selected that are most closely matched to each other. For example, for each group of rows, one available row may be selected, and a predetermined number of the other available rows are chosen which deviate least from the one row using a sum of squares of the differences between the image content at each column position.

The column data set to be used to address the rows of group can be selected to be one of:

(i) the minimum image content among the group of rows for each column position within the row;
(ii) the maximum image content among the group of rows for each column position within the row; or
(iii) the average image content among the group of rows for each column position within the row.

Alternatively, a different function may be used, for example taking into account information from neighbouring pixels which are not in the row group, so that the perceived brightness, contrast or resolution can be improved. The column data set may also be chosen to facilitate particle movement within the pixels.

The column data set may be static and the same row address signals applied to all rows in the group. However, in order to improve further the quality of the image produced by the first addressing cycle, different row address signals can be applied to different rows of the row group during the simultaneous application of the column data set.

This can enable different rows to respond differently to the same column data set so that the image can be closer to the desired final image.

The invention also provides an electrophoretic display device, comprising an array of rows and columns of display pixels, and a controller for controlling the display device, wherein the controller is adapted to implement the method of the invention.

The invention also provides a display controller for an electrophoretic display device, adapted to implement the method of the invention.

Examples of the invention will now be described in detail with reference to the accompanying drawings, in which:

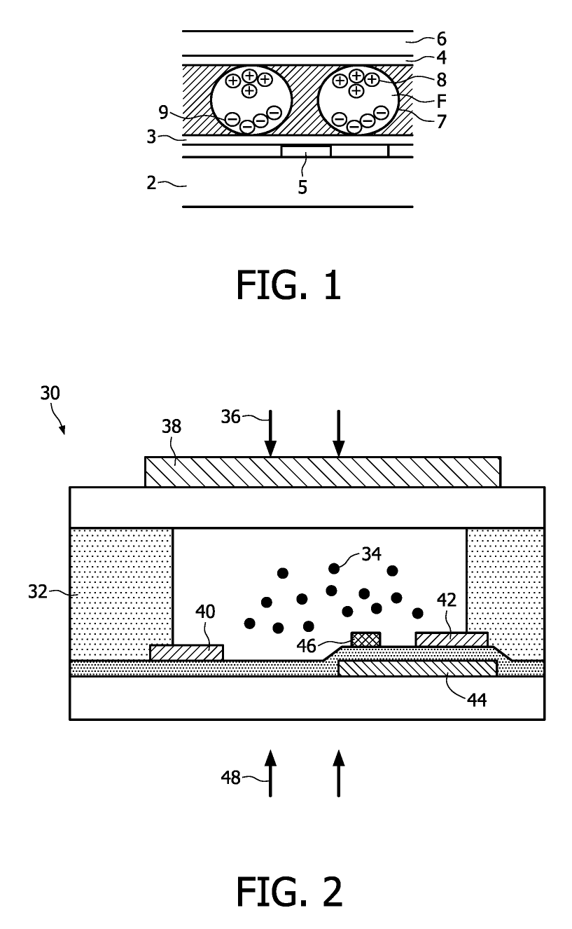

FIG. 1 shows schematically one known type of device to explain the basic technology;

FIG. 2 shows another known type of device and which will be used to explain the invention in more detail;

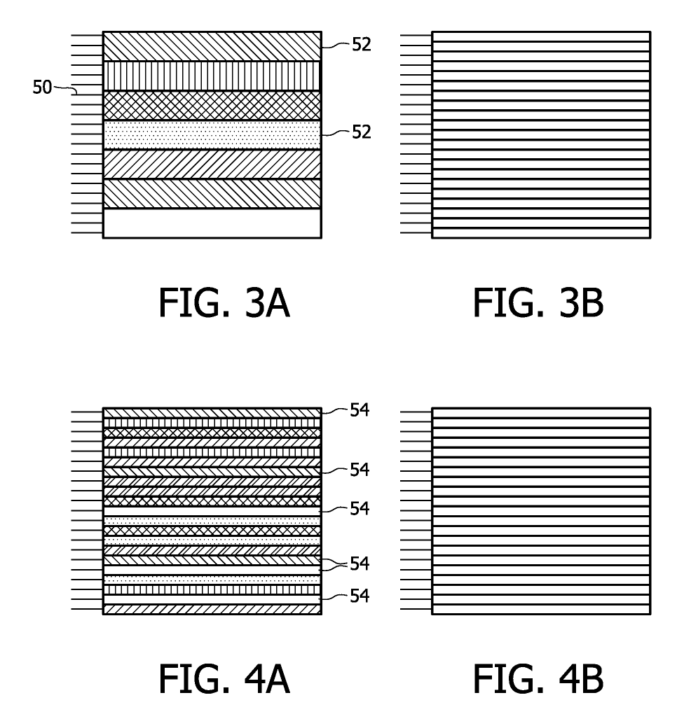

FIGS. 3A and 3B show how a first set of output images are formed resulting from the method of the invention;

FIGS. 4A and 4B show how a second set of output images are formed resulting from the method of the invention;

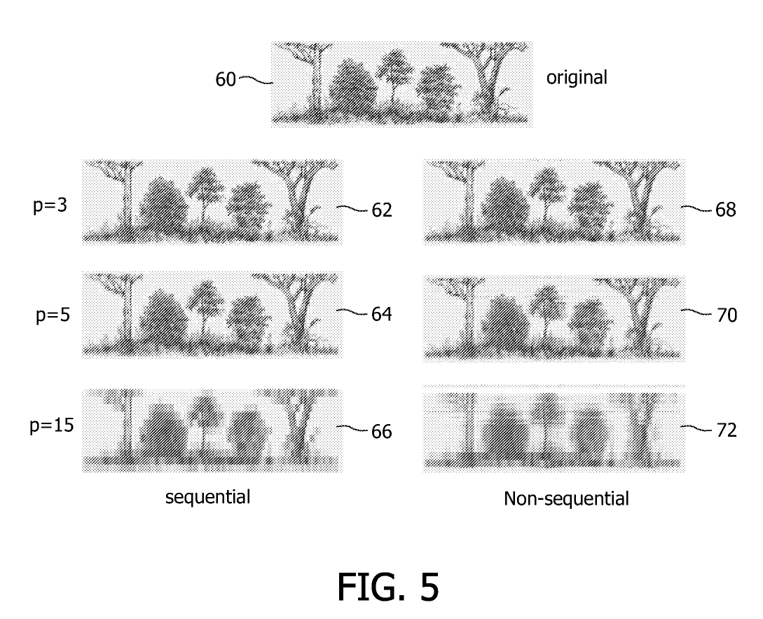

FIG. 5 shows a set of actual output images resulting from the method of the invention; and

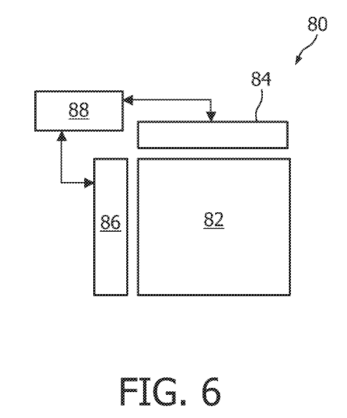

FIG. 6 shows a display device of the invention.

The same references are used in different Figs. to denote the same layers or components, and description is not repeated.

The invention provides a passive matrix electrophoretic display device and drive method in which a first display addressing cycle addresses the display as a first set of row groups, the same column data set being applied to the each row of the row group simultaneously. This provides an initial lower quality image output, and at least one further display addressing cycle is used to produce the desired output image. This reduces the addressing time to obtain an initial lower quality output image.

Before describing the invention in more detail, one example of the type of display device to which the invention relates will be described briefly.

FIG. 1 diagrammatically shows a cross section of a portion of an electrophoretic display device 1, for example showing only a few display elements, comprising a base substrate 2, an electrophoretic film with an electronic ink which is present between two transparent substrates 3,4 for example PET (polyethylenenapthalate). One of the substrates 3 is provided with transparent picture electrodes 5 and the other substrate 4 with a transparent counter electrode 6.

The electronic ink comprises multiple micro capsules 7, of about 10 to 50 microns. Each micro capsule 7 comprises positively charged white particles 8 and negatively charged black particles 9 suspended in a fluid F. When a positive field is applied to the picture electrode 5, the white particles 8 move to the side of the micro capsule 7 directed to the counter electrode 6 and the display element become visible to a viewer.

Simultaneously, the black particles 9 move to the opposite side of the microcapsule 7 where they are hidden to the viewer. By applying a negative field to the picture electrodes 5, the black particles 9 move to the side of the micro capsule 7 directed to the counter electrode 6 and the display element becomes dark to a viewer (not shown). When the electric field is removed, the particles 8,9 remain in the acquired state and the display exhibits a bi-stable character and consumes substantially no power.

The display is driven using a row driver and a column driver.

The invention relates to passive matrix displays. It is known that passive matrix schemes can use a threshold voltage response to allow the addressing of one row of pixels not to influence the other rows that have already been addressed. In this case, the combination of row and column voltages is such that the threshold is only exceeded at the pixels being addressed, and all other pixels can be held in their previous state.

FIG. 1 shows a lateral displacement electrophoretic display. The invention will be described in more detail with reference to the preferred implementation in an in-plane switching passive matrix transmissive display device.

FIG. 2 shows an example of the type of display device 30 which will be used to explain the invention, and shows one electrophoretic display cell.

The cell is bounded by side walls 32 to define a cell volume in which the electrophoretic ink particles 34 are housed. The example of FIG. 3 is an in-plane switching transmissive pixel layout, with illumination 36 from a light source (not shown), and through a colour filter 38.

The particle position within the cell is controlled by an electrode arrangement comprising a common electrode 40, a storage electrode 42 which is driven by a column conductor and a gate electrode 46 which is driven by a row conductor.

The relative voltages on the electrodes 40, 42 and 46 determine whether the particles move under electrostatic forces to the storage electrode 42 or the drive electrode 40. The storage electrode 42 (also known as a collector) defines a region in which the particles are hidden from view, by a light shield 44. With the particles over the storage electrode 42, the pixel is in an optically transmissive state allowing the illumination 36 to pass to the viewer on the opposite side of the display, and the pixel aperture is defined by the size of the light transmission opening relative to the overall pixel dimension.

In a reset phase, the particles are collected at the storage electrode 42. The addressing of the display involves driving the particles towards the electrode 40 so that they are spread within the pixel viewing area. The layout of FIG. 3 is used below to provide a mathematical analysis of the particle movement behaviour.

The invention provides a drive method by which an image is built up in several frames (referred to as “addressing cycles”), and in at least one of the frames more than one line is addressed at the same time, with the same column data set.

At least the first frame is selected for multiple lines to be addressed simultaneously. As a consequence, at the end of the first frame, a low contrast image with a low vertical resolution will appear. In one or more subsequent frames, progressively higher resolution images may be realised by addressing less rows simultaneously. In at least one final frame, all rows are addressed individually to provide a full resolution picture.

FIG. 3 shows this approach, and shows a first low vertical resolution frame in FIG. 3A and a second normally addressed full resolution frame in FIG. 3B. In FIG. 3A, the row address lines 50 are shown, and the rows are shown divided into groups 52 of three rows. The hatching shared between each successive group of three rows is used to illustrate that these rows are addressed with the same column data. As a result, a single line time can be used to address the three rows in each row group.

As the image is built up in multiple frames, for the viewer to perceive a fast update, it is important that the image present after the first frame is as close to the final image as possible. The following updates should be perceived as merely improving the already existing image, rather than being part of building up the image.

If p rows at a time are addressed for a display with N lines, the vertical resolution is reduced by a factor p. The example of FIG. 3 shows an approach in which rows 1−p are first addressed, then rows p+1 to 2p, etc. This provides a simple addressing scheme which does not require any analysis of the image content, but in general this does not generate the image closest to the final image.

It is instead possible to choose any p lines in the display at one time, and there is no need for sequential lines. Thus, the row groups can be interlaced, and the rows to be grouped together can be selected based on the image content.

FIG. 4 shows this approach, again with groups of three rows addressed at a time. FIG. 4A again shows rows addressed at the same time, and therefore with the same column data set, with the same hatching. Thus, there are again groups 54 of rows. FIG. 4B again shows all rows to illustrate that they are addressed individually.

In order to determine which rows to group together, rows can be selected which have least deviation from each other in terms of the image content at each column position along the row.

One signal processing option is to achieve this is set out below. Assuming the display consists of N lines, and is addressed with p lines at a time, and has G grey scales:

Each pixel has a grey level gᵢⱼ, where i is the row number and j is the column number. For each row k a number Fₖ is calculated defined by:

$${F}_{k} = {\sum }_{j} {( {g}_{1 j} - {g}_{kj} )}^{2}$$

This represents a sum of squares difference between the row k and the first row, summing the difference squared for each pixel along the row (i.e. for all columns j).

The p lines can then be selected with the lowest value of F (where of course F₁=0 is the lowest value). Thus first group of rows comprises row 1 and p−1 other rows. The grey levels to be applied to the columns for these first set of p rows can be set to:

the minimum grey level of the set of rows within each column;

the average grey level of the set of rows within each column; or

the maximum grey level of the set of rows within each column.

A different function of the grey levels in each column, which optimises the display performance, for example by allowing easier emptying of the pixels in the second frame, or achieving a higher perceived contrast, or a higher perceived brightness, or reducing cross-talk.

This procedure is then repeated with the remaining N−p lines, by calculating F, the sum of squared difference between the grey levels of the first line in the remaining set of lines and the grey levels of the other lines in the remaining set of lines. In this way, the driving sequence can be determined in N/p−1 calculation steps which become increasingly easier because fewer lines remain in the calculation. In total a value of F has to be calculated N²/2p times.

FIG. 5 illustrates the results of simple sequential addressing (FIG. 3) and non-sequential addressing (FIG. 4) for an image, and for three different values of p.

The original image is shown as 60. The image after the initial low resolution addressing cycles for the simple sequential scheme is shown as 62,64,66 for p=3, 5 and 15 respectively.

The image after the initial low resolution addressing cycles for the interlaced scheme outlined above is shown as 68,70,72 for p=3, 5 and 15 respectively.

Some artefacts (horizontal stripes) are introduced into the low resolution image output, but these could easily be removed by an additional “horizontal stripe detection” algorithm which compares the original image with the rendered image, or by improving the algorithm.

Typically, the image after the first addressing cycle is quite acceptable for low values of p (3 to 5), and contains too many artefacts for p≧10. A five times faster update speed is therefore achievable.

There are of course numerous variations to the simple algorithm described. For example, it is possible to choose to start addressing those lines that contain the most detailed horizontal information, or—if it is known—the most important information, or that part of the image that is most different from the previous image.

After the low resolution image has been written, it may be possible not to address the full image in the next or last addressing cycle, as some rows may have been correctly written already. The number of lines where the image needs correction may be quite low, and even the total update time (frame 1+frame 2) can therefore be lower than with conventional driving.

The invention has been described in connection with an in-plane switching arrangement, but the concepts can be extended to other configurations.

One example of display has been given with row and columns in a particular orientation. The orientation is however somewhat arbitrary. The row is in the example given the conductor to which a select signal is applied and the column is the conductor to which the data signal is applied. These may be switched around, and it should therefore be understood that a “row” may run from top to bottom, and a “column” may run from side to side. The scope of the claims should be understood accordingly.

FIG. 6 shows schematically that the display 80 of the invention can be implemented as a display panel 82 having an array of pixels, a row driver 84, a column driver 86 and a controller 88.

The number of rows to group together can be selected depending on the required addressing time for the first image compared to the required image quality. The number may typically be 3, 4 or 5.

The approach outlined above applies the same and constant column data set to the group of rows over the full duration of the row addressing period, and applies the same and constant row addressing signals to the rows of the group, so that the rows of the group are all addressed in exactly the same way. However, this is not a requirement, and it is possible to address different rows within the group differently, although with the column data set shared. This may enable the quality of the image after the first addressing cycle to be improved further.

The row and column signals may also not comprise constant voltages, but they may vary over time and/or comprise pulsed voltage signals.

Various modifications will be apparent to those skilled in the art.

1. A method of driving a passive matrix electrophoretic display device that includes an array of rows and columns of display pixels, the method comprising:
carrying out a first display addressing cycle, wherein the display is addressed as a first set of row groups (52), the same column data set being applied to each row of the row group simultaneously, wherein the number of row groups (52) is less than the number of rows (50), such that at least one row group comprises a plurality of rows; and
carrying out at least one further display addressing cycle (FIG. 3B), wherein in the final addressing cycle all rows (50) of the display are addressed with independent image data.

2. A method as claimed in claim 1, wherein each row group (52;54) comprises a plurality of rows.

3. A method as claimed in claim 2, wherein each row group (52;54) comprises the same number of rows.

4. A method as claimed in claim 2, wherein the first row group (52) comprises a first plurality of adjacent rows, and each next row group comprises a next plurality of adjacent rows.

5. A method as claimed in claim 2, wherein the row groups (54) are interlaced.

6. A method as claimed in claim 2, further comprising determining which rows to group together based on the image content.

7. A method as claimed in claim 6, wherein determining which rows to group together comprises grouping the rows which have least deviation from each other in terms of the image content at each column position along the row.

8. A method as claimed in claim 7, wherein determining which rows to group together comprises, for each group of rows, selecting one available row, and selecting a predetermined number of the other available rows which deviate least from the one row using a sum of squares of the differences between the image content at each column position.

9. A method as claimed in claim 1, wherein the common row content for each group of rows is selected to be one of:
(i) the minimum image content among the group of rows for each column position within the row;
(ii) the maximum image content among the group of rows for each column position within the row; or
(iii) the average image content among the group of rows for each column position within the row.

10. A method as claimed in claim 1, wherein in the at least one further display addressing cycle, only rows that require different image content to the image content that has already been written are re-addressed.

11. An electrophoretic display device (80), comprising an array of rows and columns of display pixels (82), and a controller (88) for controlling the display device, wherein the controller is adapted to carry out a first display addressing cycle, wherein the display is addressed as a first set of row groups, the same column data set being applied to each row of the row group simultaneously, wherein the number of row groups is less than the number of rows, such that at least one row group comprises a plurality of rows; and carry out at least one further display addressing cycle, wherein in the final addressing cycle all rows of the display are addressed with independent image data.

12. A display controller (88) for an electrophoretic display device, the display controller being adapted to carry out a first display addressing cycle, wherein the display is addressed as a first set of row groups, the same column data set being applied to each row of the row group simultaneously, wherein the number of row groups is less than the number of rows, such that at least one row group comprises a plurality of rows, and carry out at least one further display addressing cycle, wherein in the final addressing cycle all rows of the display are addressed with independent image data.
